(19) United States
(12) Patent Application Publication
(10) Pub. No.: US 2003/0174656 A1
(43) Pub. Date: Sep. 18, 2003

(54) APS identification allocation in communication networks

(76) Inventors: Rodrigo Fernandez, London (GB); Yossi Kanzen, London (GB); Ian M. Rogers, London (GB)

Correspondence Address: William M. Lee, Jr., LEE, MANN, SMITH, MCWILLIAMS,, SWEENEY & OHLSON, P.O. Box 2786, Chicago, IL, 60690-2786, US

(21) Appl. No.: 10/051,929

(22) Filed: Jan. 18, 2002

(51) Int. Cl. H04L 12/28

(52) U.S. Cl. 370/255; 370/228

(57) ABSTRACT

Squelch identifiers for re-routing a broken path through interconnected network elements of a communication network incorporating BLSR protection are allocated by a method comprising: determining chain links between network elements; setting attributes (begin, middle, end) corresponding to the chain links; building chains by joining chain links together; matching pairs of chains connecting network elements at the ends of chains; and allocating squelch identifiers to those network elements interconnected by matching pairs of chains. Each chain link represents two termination points and an intermediate subnetwork connection. The step of building chains comprises joining chain links having matching termination points. The step of matching pairs of chains comprises searching for chains interconnecting the same two network elements but pointing in opposite directions.

### FIELD OF THE INVENTION

The present invention is concerned with allocating APS attributes to network element ports in a communication network. In particular, the invention concerns an algorithm to allocate such attributes in networks protected by BLSR.

### BACKGROUND TO THE INVENTION

Communication networks, especially optical networks, such as SONET or SDH networks, support a protection scheme known as BLSR. The objective of BLSR is to provide an alternative route for data if a break or other fault occurs in the intended path through the network elements making up the network.

The following explanation is intended to illustrate the point. Part of a network can be represented by a ring of network elements (NEs) interconnected by the path allocated for the data. Each port of each NE is allocated an identifier, known as an Automatic Protection Switch (APS) ID, so that the connectivity of each port is made known to the management system of the network. In the present example, the ports in and out of an NE carry the same ID attribute. These typically range from 1 to 8. Traffic is intended to be carried over a path entering the first NE at an input port allocated an ID=1 and exiting the ring via an exit port of the NE with ID=5. The NEs along the path will therefore carry the attributes 1,5 indicating the entry and exit points of the ring. Further examples will be given in the specific description of the preferred embodiments later in the specification. It is assumed that the present example operates under the STM16 type ring, in which there are 8 slots allocated for traffic and 8 for protection.

In APS systems, it is clearly essential for the protection system manager to be able to find an alternative route round the network in the event of a fault occurring in the intended path. This function is known as “squelching”. It follows that each NE port needs to be assigned a specific identifier, the squelch identifier or squelch ID, which enables the manager to identify a suitable re-routing path. For each NE there may be up to 2 entry and up to 2 exit squelch IDs. In the situation where three rings are linked together, there will be 3 squelch IDs for the NEs indicated in the outer rings and 4 squelch IDs for the inner ring. The squelch Ids are allocated once the ring is commissioned. It is important to appreciate that a single NE can be part of two rings. In this case, the common NE may be a hub. The squelch IDs perform two functions, depending on the function/position of the NE in relation to the ring. Thus, the squelch ID will perform an aggregate function, if the NE forms part of a ring, and a tributary function, if the NE in question is located in a part of a ring where paths may enter or exit the ring.

In known communication networks operating with protection systems such as BLSR, the squelch Ids have had to be entered manually, once the rings have been commissioned. This can be a time-consuming operation. It is beneficial if the client can be spared this task. There is a therefore a need in communication networks operating with protection systems to generate the squelch IDs automatically.

### SUMMARY OF THE INVENTION

A method of allocating squelch identifiers in a communication network incorporating BLSR protection, the network comprising a plurality of interconnected Network Elements (NEs), the method comprising:

Determining chain links between NEs;

Setting attributes (begin, middle, end) corresponding to the chain links;

Building chains by joining chain links together;

Matching pairs of chains connecting NEs at the ends of chains; and

Allocating squelch identifiers to those NEs interconnected by matching pairs of chains.

In the above method, the chains are built up from chain links having the same terminating identifiers. Data representing the built up chains can then be searched to establish pairs of chains interconnecting the same two NEs but pointing in opposite directions.

Each chain link preferably consists of a termination point at each end and an intermediate sub-network connection (SNC). Each termination point (TP) is a representation of the relevant port in a specific layer/traffic rate in a layered protocol and each SNC represents the connectivity between 2-4 termination points.

The invention also includes a BLSR-protected communication network provided with squelch identifiers according to the above method, to signals transmitted over such a network and to a carrier for an algorithm adapted to perform the squelch identifier allocation method.

### BRIEF DESCRIPTION OF THE DRAWINGS

The invention will be described with reference to the following drawings, in which:

FIG. 1 represents a Trail with two broken lines;

FIG. 2 represents a multi-span ring;

FIG. 3 represents a real trail in two rings

FIG. 4 represents a real trail ion three rings;

FIG. 5 contrasts earlier attempts at solving the problem addressed by the invention;

FIG. 6 represents current chains in the solution according to the invention;

FIG. 7 represents new chains in a protected ring;

FIG. 8 is a general flow diagram showing chain building;

FIG. 9 is a flow diagram showing protected SNC processing;

FIG. 10 is a flow diagram showing Recuirsive Chain Building;

FIG. 11 is a flow diagram showing Chain Link Processing;

FIG. 12 is a flow diagram showing the building of Chain Pairs;

FIG. 13 represents the new APS ids Class Diagram;

FIG. 14 is a component diagram;

FIG. 15 is a calculator Class Diagram;

FIG. 16 is an APS TPs Class Diagram;

FIG. 17 is a Chain Link Class Diagram;

FIG. 18 is a Chain Pair Class Diagram;

FIG. 19 is a typical example of Match Node Architecture;

FIG. 20 illustrates a stage reached in part of the allocation process;

FIG. 21 illustrates the results of the above stage;

FIG. 22 illustrates a stage reached in connection with a hub;

FIG. 23 illustrates the corresponding results; and

FIG. 24 is a block diagram of the preferred allocation mechanism.

### DETAILED DESCRIPTION OF THE ILLUSTRATED EMBODIMENTS

The objective of the invention is to provide an automatic system for allocating squelch Ids enabling a communication path through a network to be re-routed if there is a break or other fault in the intended path or in a NE along that path. In essence, an algorithm establishes all the chain links between adjacent pairs of NEs. Each such link contains a subnetwork connection (SNC) and a termination point (TP) at each end. Data representing these chain links are stored and individual chains built up from connectivity data linking NE to NE. A search is then conducted to find matched pairs of chains. These pairs will be chains that start and end at the same NEs but point in opposite directions through the chain. It is then comparatively straightforward to allocate the squelch Ids once the path is recognised.

In this specification, two scenarios will first be considered which current Squelch Id allocation systems cannot cope with, then the situation in a real NE will be considered, and the solution to the problem will be presented, with the previous sections in mind.

1. Two lines broken scenario/One node failing

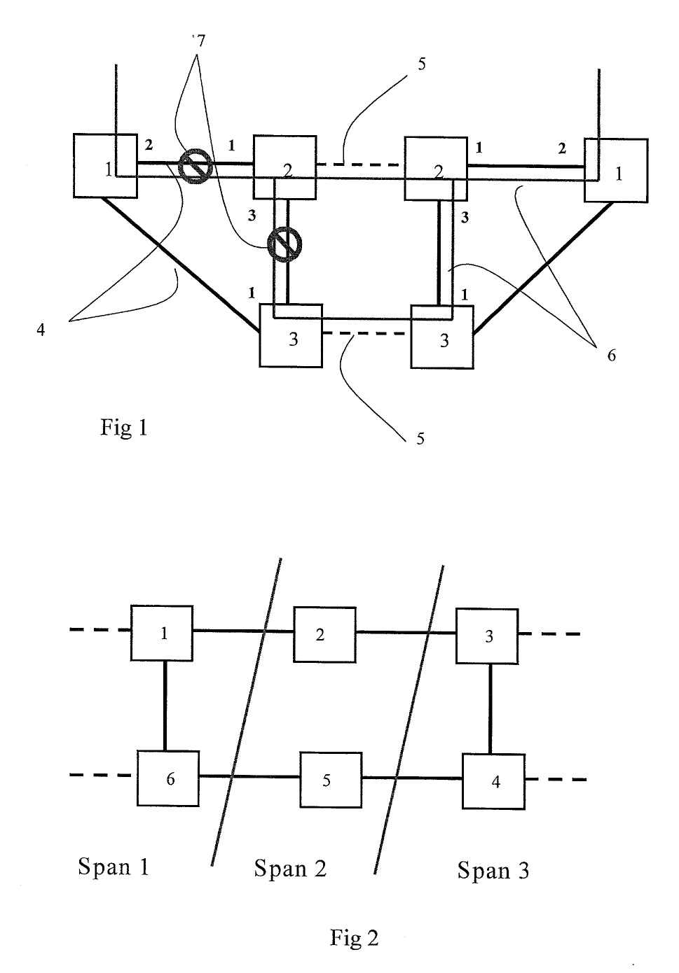

FIG. 1 represents the two lines broken scenario in which two rings comprising three nodes 1, 2, 3 interconnected by paths 4, are themselves interconnected, one ring with the other, by two tributaries represented by dashed lines 5. The numbers 1, 2, 3 inside the nodes are the port Ids. The inner lines 6 represent the trail. This opens protection in node 2 in the first ring and closes it in node 2 in the second ring. If the two trail lines in the first ring are cut, as indicated at 7, the traffic from node 1 will not be able to reach node 2. However, traffic can still get out of the ring using node 3 in the first ring, since the trail is protected using this node. This suggests the introduction of a second APS Id which, in this case, will be 3 in node 1.

This scenario is equivalent to the one node failing scenario. This would happen if node 2 in the figure fails. The result is the same as in the previous case.

2. Multi span ring scenario

The second scenario happens when a ring is controlled by different spans, such as illustrated in FIG. 2. There are three different spans controlling the ring. Each span controls two nodes.

Consider a trail that goes through node 2. This node knows nothing about the nodes controlled by Span 1 and Span 2, and the trail enters the ring through these nodes, so if something happens node 2 will not be able to re-route the traffic using only one APS Id. It needs to know exactly which nodes are used to enter and exit the trail in the ring.

A real NE

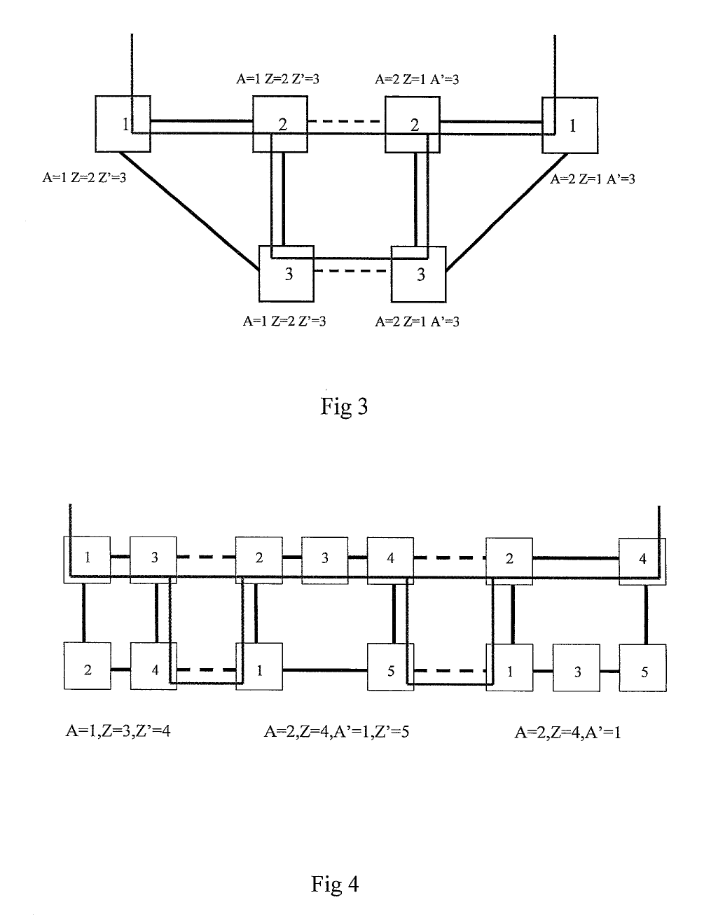

In a real ring each NE will have 4 variables: namely A, A′ (A prime), Z and Z′ (Z prime). A is the node through which the trail enters the ring and Z the node through which the trail exits it. The prime variables are the protection nodes to A and Z. In this way, if the trail is not protected only A and Z will have value. These variables will be the same in every node in the ring belonging to the same trail. FIG. 3 shows the application to the trail in FIG. 1. There are two different set of values, one per ring. In the first ring A′ does not have any value, since A is not protected. On the second ring the situation is the same with Z′.

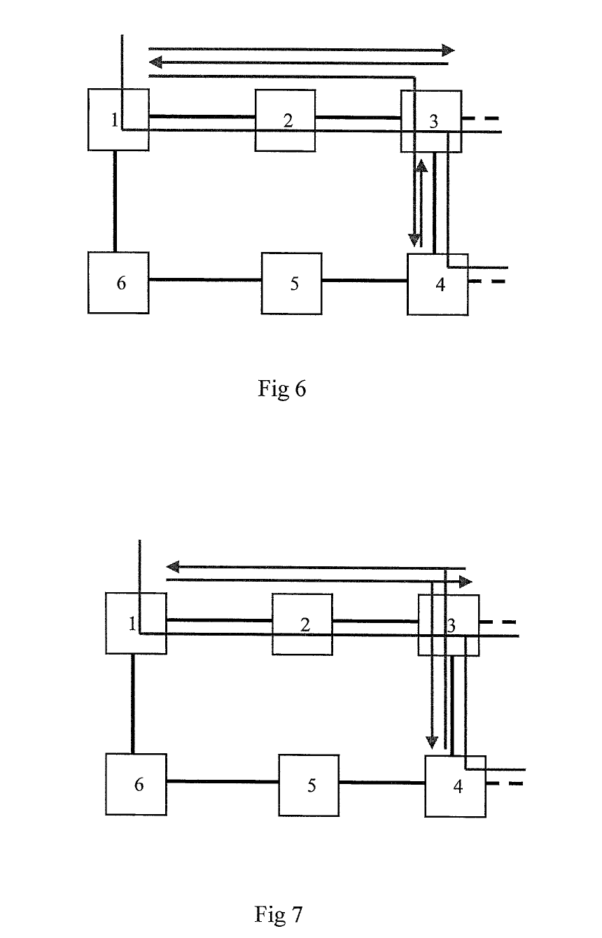

Another scenario is the case in which the four attributes are all needed, as shown in the middle ring 1-5 in FIG. 4.

The solution

In network management solutions where there is only one value of APS Id, it is not enough to cope with all the possible scenarios. Also, in the current APS Ids implementation the Squelch Ids are set in each TP. This means that two TPs belonging to the same NE can have different Ids, and of course, these values will be different in each node in the ring, while in the real implementation these values are the same in every node.

The present invention uses a different approach, approximating closer to the real implementation of NEs in a network. As already mentioned, four attributes A, A′, Z and Z′ are utilised. When these attributes are utilised in a communication network using trails (the present applicant operates a network using a specific management system known as Trail Manager, or TM for short) these TM attributes will be represented by TPAM attributes, like the current squelch Ids. Their correspondence is represented in the following table:

TABLE 1
APS ID attribute correspondence

| Real Attributes | TM Attributes | TPAM Attributes |
|---|---|---|
| A, Z | A | A_SquelchApsId |
| A′, Z′ | A′ | A_Prime_SquelchApsId |
| A, Z | Z | Z_SquelchApsId |
| A′, Z′ | Z′ | Z_Prime_SquelchApsId |

In this specification, a convention is used for labelling the entries and exits. Wherever there are two entries or exits to/from a node A, say, they will be indicated by A and A′ (A Prime), as shown in FIGS. 3 and 4, for example

In contrast to a known technique for identifying APS Ids, which utilises the three steps of (1) Building Chain Links; (2) Building Chains using Chain Links; and (3) Allocating the Ids, the present invention, in its preferred form, builds the chains in such a way that there are only two chains per ring, one in each direction. The new chains have branches. They will begin in the entry to the ring node and will finish in the exit to the ring node. If there are two exits or two entries the chain will have branches. The manner in which these three steps are implemented will be described as follows. In the known technique of FIG. 6 there are four chains, two in each direction. The new chains will have only two chains, one per direction. These chains will span all the ring and they will have branches, as can be seen in FIG. 7:

The chain to the right has one begin and two ends, while the other one has one end and two begins. The new algorithm will be able to build these chains. In contrast, the new chains are built using the same chain links produced by the first step in the previous algorithm, so it is being re-used. This is very important since this is the most difficult and most code consuming step.

Once the new chains are created, the Ids can be allocated. This will be done, in this embodiment, in two different steps, namely:

1. Identify A, A′, Z and Z′.

2. Set the attributes in all the TPs in the ring.

In the first step, referring to FIG. 7, the beginning of the chain is to the right. Z and Z′ are the begins of the chain to the left. Z is the begin in the node with protection, while Z′ is the begin of the one without protection.

The second step is to set the attributes. In order to do that, the attributes of all the TPs in one of the chains are set, using the values calculated in the previous section.

Building chains algorithm

As explained before, now there will be two chains per ring, one in each direction. These chains will therefore have branches, so the algorithm is designed to cope with the new situation.

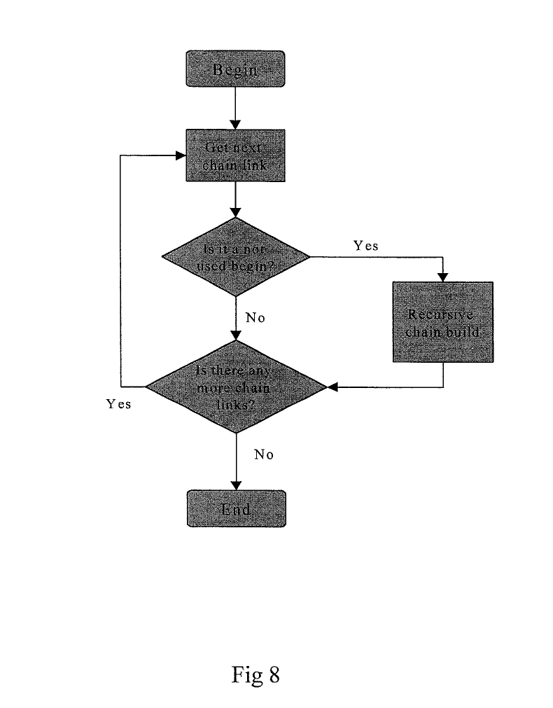

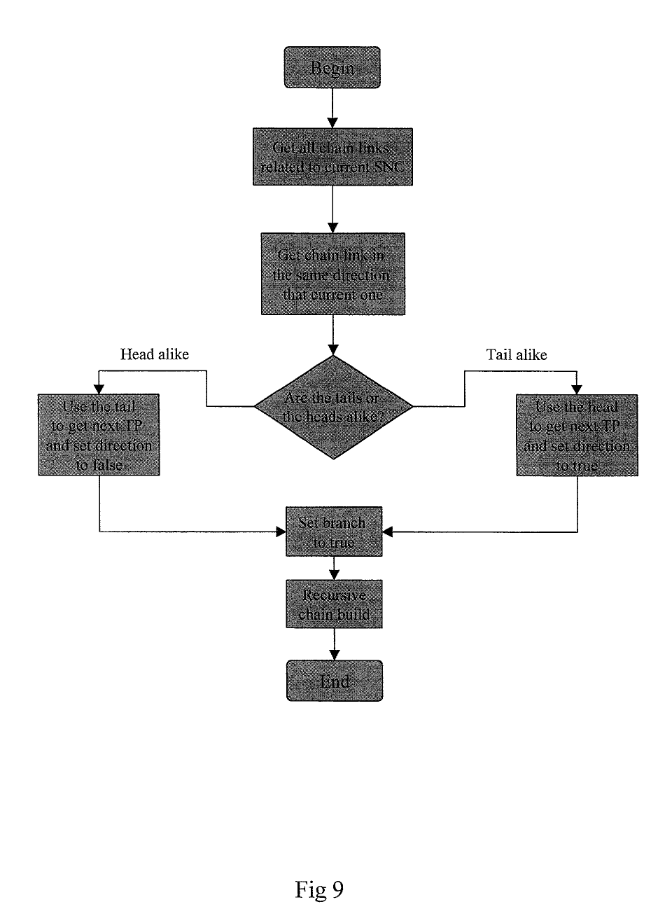

Referring to the Building Chains General Flow diagram of FIG. 8, at the beginning of the algorithm there is a list containing all the chain links in the trail. These chain links will now have an SNC identifier, a unique number that identifies which SNC a chain link is related to. In this way it can be determined if two different chain links are related to the same SNC. From here a loop is performed through every chain link. If the beginning of a chain link is found, a new chain is created and the chain link is added to the chain. At this point the following process starts (see FIG. 9):

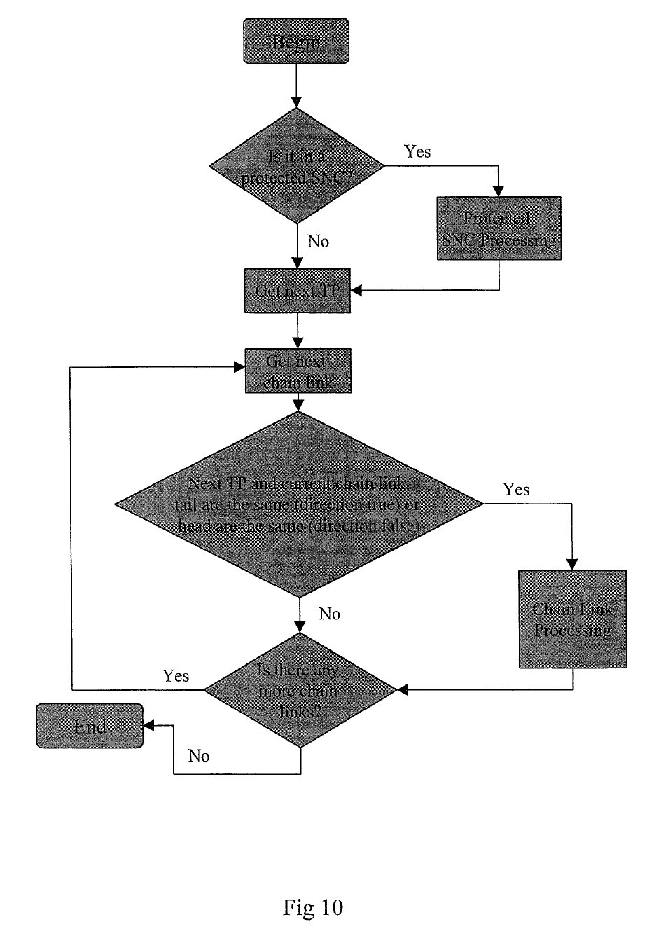

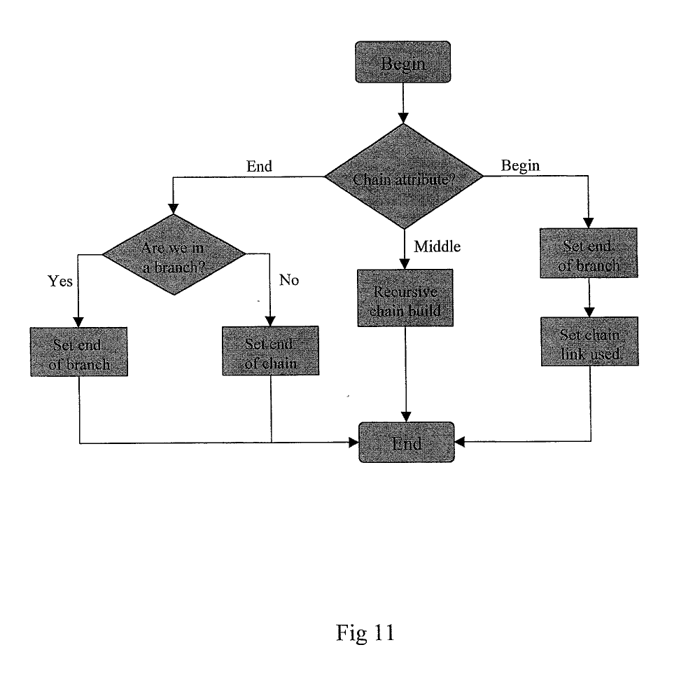

1. Check if the chain link is in a protected SNC. If it is, all the chain links related to the same SNC (using the SNC identifier) are investigated so as to select the one in the same direction as the chain link in question. This checking is done if the tails or the heads are the same. If the tails are the same this means that the branch of the chain goes from begin to end (the next TP is determined from the head). If the heads are the same the branch goes from end to begin and the Direction variable is set to FALSE (the next TP is determined from the tail). A recursive call is performed to the function that contains the algorithm for every new-found branch. Once finished, the process continues (see FIG. 10):

2. Get the next TP from the current chain link and perform a loop through every chain link. Check if the next TP and the tail of the current chain link are the same and the direction is TRUE (direction begin to end) or if the head of the current chain link are the same and the direction is FALSE (direction end to begin). If it is, add the chain link to the chain and continue.

3. Check if the chain link is a begin, a middle or an end.

3.1. End. If not in a branch, consider that it is the last chain link in the chain and return, setting the end to true. If in a branch, simply return setting the end of the branch.

3.2. Middle. call again the algorithm recursively.

3.3 Begin. There can only be a begin at this point if in a branch and the direction is end to begin. So set the end of the branch, set the begin chain link to used, do not begin a new chain if find it later on, and return.

APS Ids allocation algorithm

At this point every chain in the trail has been built. There are two chains per ring. Now the attributes have to be determined. In the preferred implementation, this is done in two steps:

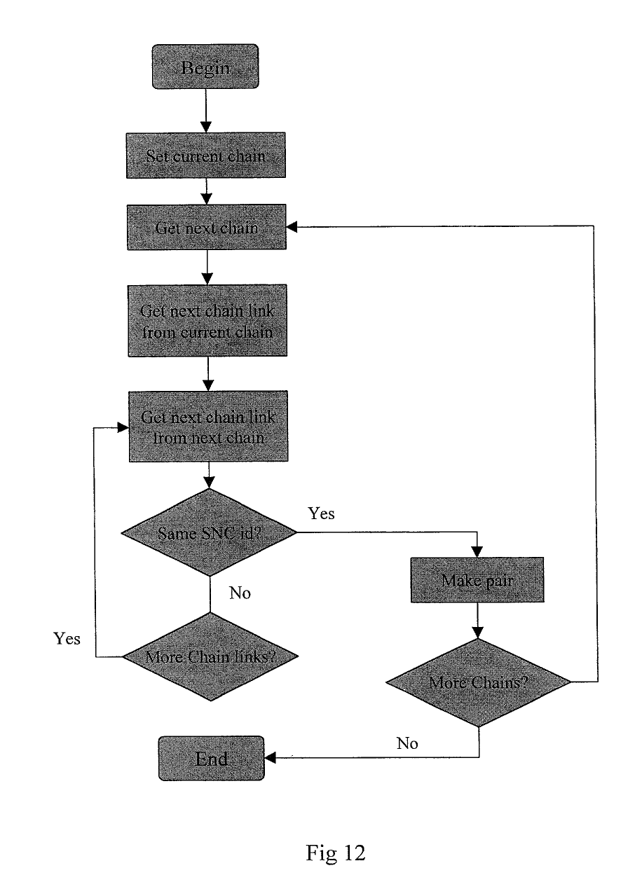

1. Build pairs: the first step is to group the chains in pairs. The flow diagram is shown in FIG. 12. The pairs will store the chains belonging to the same ring. In order to do that it is only necessary to check the SNC Ids. If the two chain links are found to belong to different chains and with the same SNC Id these two chains come from the same ring. There is a case when this is not true, namely when a node belongs to two rings at the same time. In this case there will be four chains with chain links having the same SNC Id so the next chain link will be investigated. In this case there will be no error.

2. Identify the attributes: a collection of chain pairs has now been built up. Each of those will have one or two begins and one or two ends. In the process of chain link creation the direction of the chain links had been set, so the direction of each chain in the pair is known. When a two direction chain link is registered, the one to the right is registered first and then the one to the left. The direction is also registered. So, in order to identify the attributes, the direction and the begins are needed (they will be the attributes). The following cases exist:

Two begins (one per chain): this is an unprotected trail. The A will be the begin with direction TRUE (to the right) and Z will be the other one.

Three begins (one in a chain and two in the other): now there will be a prime attribute in the chain with two begins. To decide which one is the prime, look at the SNC related to the chain link. If it is protected it will be the no prime and the prime will be the one in the protected SNC. So the node with protection will be A, the one in the same chain without protection will be A prime and the one in the chain with only one begin will be Z.

Four begins (two per chain): there will be two begins in both chains so it is necessary to decide which ones are A and which ones Z. The direction will be checked as above. The As will be the ones with direction TRUE (to the right) and Zs will be the others.

There are many cases in which some attributes are not needed. For example, in an unprotected trail the prime attributes will not be used. In these cases they will have value −1, that is a forbidden value for APS Ids.

Software Specification

This section of the description sets out a class diagram and explains each class and the relationships between them.

Modular Structure

Class diagram

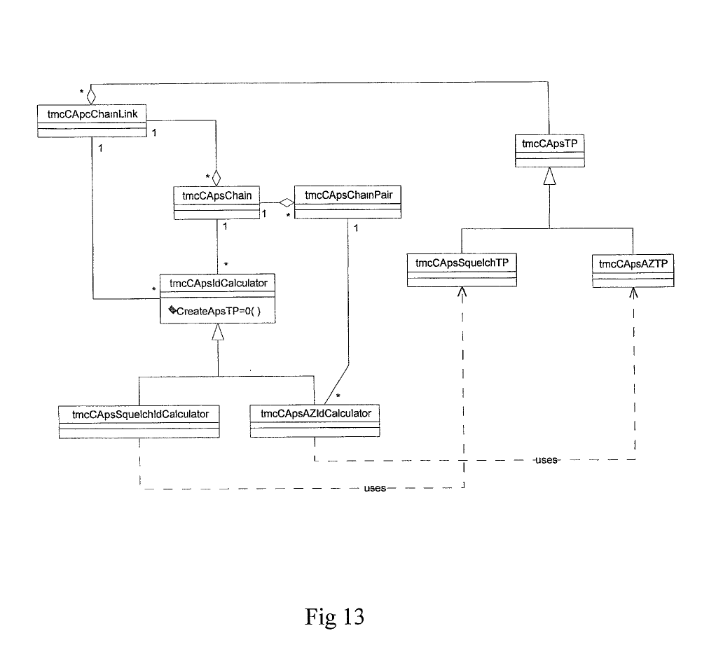

FIG. 13 shows the class diagram for new APS Ids. In this diagram, neither function nor attributes are included for the sake of simplicity of the drawing. They will be explain in the next section.

Referring to FIG. 13, all the classes and the relationships drafted in the previous section are depicted. The base classes and those derived from them can be seen. The base classes are abstract classes, which means that they cannot be instantiated. The following characteristics can be noted:

A chain is composed by chain links.

A chain pair contains two chains but it is not composed by them since it contains methods to calculate the Ids.

A chain link contains two APS TPs.

The class tmcCApsIdCalculator has a list of pointers to tmcCApsTP objects. These objects belong to the class tmcCApsSquelch or tmcCApsAZTP depending on the class of calculator instance. As seen in the diagram (dashed line relationship), each kind of Calculator will use a kind of TP but the code to register TPs is in the base class and it needs to know the class of the TPs that it is creating. In order to solve this problem the base class has a pure virtual function called CreateApsTP. This function will return a new APS TP object in the heap and is implemented by the derived classes. Each of these classes specifies in this way the kind of TP it wants to use.

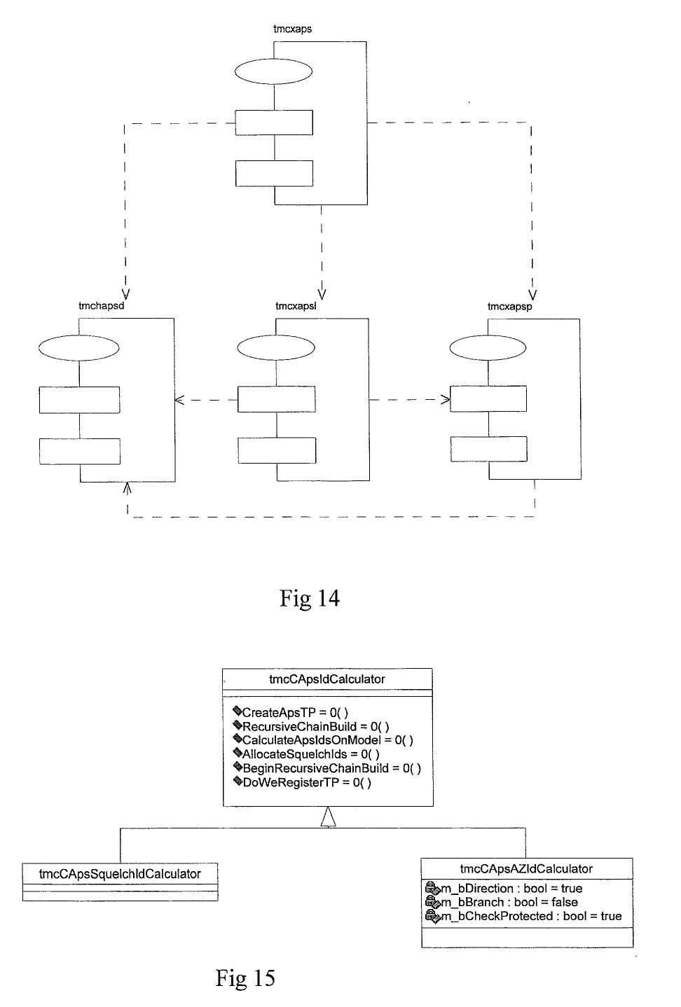

One more class is needed in the diagram, namely the class that manages the process. It creates two calculators (one of each kind) and then it calls the proper functions to process the Ids. This class is called ProcessApsIds. The component diagram is shown in FIG. 14.

The boxes in the figure represent the APS files. All of them, except tmchapd, are implementation files. The boxes include their header files. The file tmchapd does not have implementation file but it plays an important role in the diagram. Each module contains the following classes:

tmdxaps:

1. tmcCApsIdCalculator

2. tmcCApsSquelchIdCalculator

3. tmcCApsAZIdCalculator

4. ProcessApsId.

tmdxapsp:

1. tmcCApsTP

2. tmcCApsSquelchTP

3. tmcCApsAZTP.

tmdxapsl:

1. tmcCApsChain

2. tmcCApsChainLink

3. tmcCApsChainPair

tmdhapsd: constants and definitions used by the other modules.

Module/Procedure Description

All the classes of the class diagram will be described here.

tmcCApsIdCalculator

This is the main class in the class structure. Previously, it was an object of the class invoked from tmcore to perform the whole APS Ids calculation process. In the preferred embodiment of the invention, it will be done by ProcessApsIds, but the calculation itself will still be done by this class. As previously mentioned, the current class is split up into two new classes: one to calculate current APS Ids (tmcCApsSquelchIdCalculator) and the other to calculate the new ones (tmcCApsAZIdCalculator). The common code used by them is placed in a base class and particular code will be placed in two derived classes.

As can be see in the Calculator Class Diagram in FIG. 15, the base class defines four pure virtual classes that the derived classes must implement:

CreateApsTP: The common code in the base class needs to create APS TP objects. These objects can belong to two different class, but this is only known by the derived classes, so it must be decided by them. This function will be called whenever there is a need to create an APS TP object and it will return a base class pointer to an APS TP object in the heap. The class of this object is define by the derived classes when implementing this function.

RecursiveChainBuild: This function builds chains through a recursive process. The one implemented in the tmcCApsSquelchIdCalculator is the same that the one in the current code. The new one is very different and it encapsulates the main part of the algorithm to build chains described before.

CalculateApsIdsOnModel: This function calculates the APS Ids. The one implemented in the tmcCApsSquelchIdCalculator is the same that in the current code. The new function performs the calculation in two steps. First, it creates chain pairs and then it “tells” this pair to assign the values.

BeginRecursiveChainBuild: This function sets the object to be ready to call the recursive chain function. Since the function to create chains is common and the preparations to call the recursive process are different for both algorithms, this function is provided.

DoWeRegisterTP: This function is called to decide if a TP is registered or not. Since this decision depends on the attributes and they are different in both algorithms this virtual function is provided.

AllocateSquelchAps: This function calls the function to build the model and then goes through all the TPs in it to allocate the APS Ids. This is the function called from the ProcessApsId object, this is the reason why it is pure virtual, to make all the derived classes define it.

Apart from these methods there are three new data members in the new calculator. All of them are related to the new chain building process. The chains were linear, but now they have branches. When the algorithm goes through a branch its behavior is different. In order to be able to know this situation the variable m_bBranch is set to FALSE. In the same way, in the current algorithm a chain is always built from a begin to an end. However, now it can be built from a middle to an end. In this case, the variable m_bDirection is set to TRUE. The last variable m_bCheckProtected is Boolean. It indicates when it is necessary to check if a SNC is protected. This will be needed if it has not already been checked. Its initial values will be TRUE.

ProcessApsIds

This is the class that controls the whole APS Ids calculation process. It is a functor object, that is, a class that behaves like a function (the operator( ) will be overload to be able to invoke the function through the class name). It has been done this way because this class is going to have one only method.

This class will create two calculators, one of each class, and it will execute both of them. In this way, if there is a mixture of current templates ring and new templates ring both of them will be calculated. If there are current and new templates in the same ring it will return an error.

The second calculator is executed if the error code is different or not Ok. For example, if it is ring not complete it is executed anyway. This is done to maintain the support for incomplete trails.

tmcCApsTP

As explained in previous sections there are two different classes of APS TPs, each one of them for each calculator. The main difference between them is that the current TP has one attribute and the new one has four, plus the Set/Get functions.

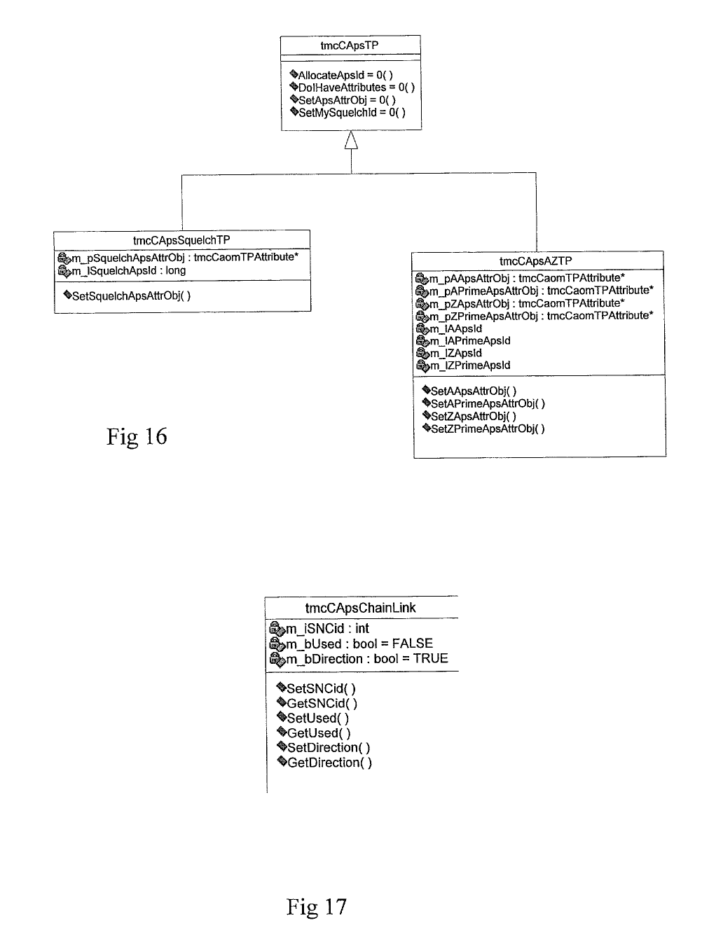

Referring to FIG. 16, which represents the class diagram structure for the APS TPs, the base class defines two pure virtual functions. The first one, AllocateApsIds, sets the APS Ids in the variables that hold them. The difference between the previous function and the new is the number and name of the attributes. The function DoIHaveAttributes returns TRUE if the TP has the proper attributes to be set.

tmcCApsChainLink

Referring to FIG. 17, which represents the Chain Link Class Diagram, the data member m_bUsed indicates if the chain link has been used in any chain. This is important, since in the new algorithm the chain links can be used only in one chain. The data member m_bSNCid identifies the SNC which the chain link is related to. The data member m_bDirection indicates the direction the chain link works. If it is TRUE the chain link goes to the right and if is FALSE it goes to the right.

tmcCApsChain

These chain links can contain TPs of two different classes (with the same base class).

TmcCApsChainPair

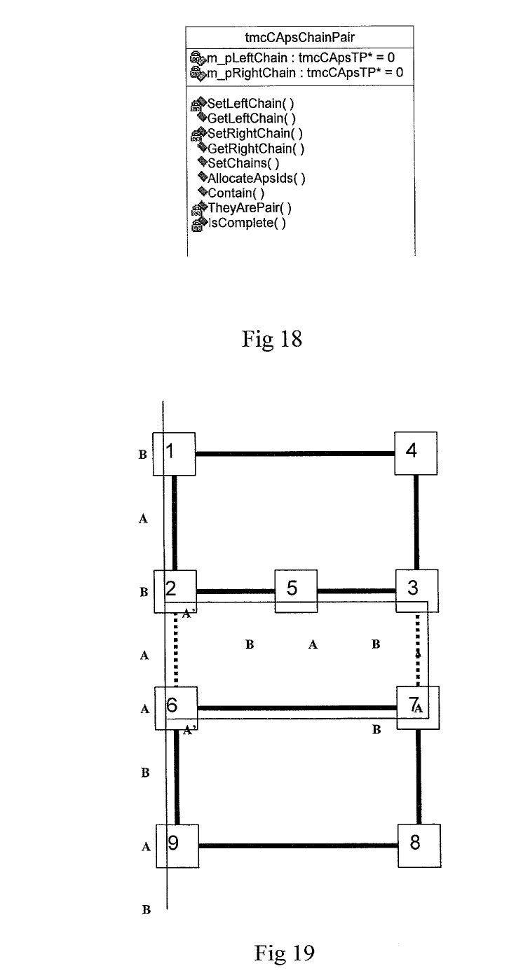

This class stores the two chains (one per direction) that represent a trail in a ring. Referring to FIG. 18, representing the Chain Pair Class Diagram, the two data members are pointers to the chains. One to the chain that goes to the right and the other to the chain that goes to the left. There are four Set/Get methods to operate the chains. As can be seen in the figure, the Set methods are private. This is because the setting is done by the SetChains method, it cannot be done from outside since it could create corruptions (chains that are not really pairs). It gets a chain and a collection of chains as arguments and it finds the other ring chain in the collection, setting both of them in the object. The method AllocateApsIds, allocates the Ids in every TP in the chains (the TPs is the same in both chains).

The last public method is Contain, used by the calculator method in charge of building chain pairs. This function gets a chain as argument and checks if it is one of the chains in the pair.

The two last private methods are TheyArePair and IsComplete. The first of these gets two chains as arguments and checks if they are a pair. This is done by getting two SNC ids from one chain and checking if the other ring contains this SNC. The first and last chain links SNC are used because it is possible that there are two chains with the same SNC in different rings (a node belonging to two rings). The second function, IsComplete, checks if a chain pair has two members.

The algorithm

This part of the specification describes a general algorithm developed to solve the problem of Squelch APS Ids allocation. The present description assumes three specific types of connection, namely: Unprotected, Protected and Closed Scissors.

In terms of the way an NE is located in a ring, the algorithm caters for regular NEs (i.e. NEs that take part in one BLSR ring only) and HUB configured ones (i.e. NEs that take part in more then one BLSR ring).

In the HUB configuration, pairs of EP that belong to different rings are assumed to have different Port Aps Id.

definitions:

In order to describe the proposed algorithm the following definitions are used:

Aps TP

A CTP supported with “SquelchApsId” subtype. (the template is assumed correct and there is a “PortApsId” attribute in the TTP of the carrying layer.)

Chain Link

An ordered pair of EP in an SNC, the first named “Head” and the second named “Tail”.

Example:

protected SNC consist of the following 4 Chain Links: {(b,a),(b,a′),(a,b),(a′,b)}

unprotected SNC consist of 2 chain Links: {(a,b), (b,a)}

A “Chain Link” holds a property (attribute) that describes its place within the Chain: one of the three options: “Begin”, “Middle”, “End”

Note: A Chain Link may have both “End” and “Begin” attributes at the same time but if it is a “Middle” it cannot have another attribute at the same time.

Aps Chain Link

A Chain Link for which at least one of its TPs is an “Aps TP”.

Chain In A Ring

A vector of at least two Aps Chain Links, such that its first component is with attribute “Begin”, the last is “End” and all the rest (if any) are with attribute “Middle”.

Example: An intersection of a Unidirectional unprotected trail with a BLSR ring is a typical Chain In A Ring.

Note: There is importance in the fact that the minimal chain is of two components.

Algorithm description:

The algorithm assumes it has been given a complete trail.

1. For each of the SNCs: for each of the TPs, if the TP is an Aps TP, create two Chain Links of the TP and its neighbour(s) wherein the first the current TP is “Head” and in the second is “Tail”.

Note: a bidirectional trail is assumed and therefore the duplication of the Chain Link creation.

1.1 Determine the attribute of the Chain Link. Regarding it as part of intersection between unidirectional trail and a ring, the following are considered:

The type of the connection (i.e. “protected”, “Unprotected” and “Closed Scissors”)

In case only one of the TPs is an Aps TP is it the “Tail” or the “Head”?

Are the Port Aps Ids equal/different in the Tail from the Head?

In case they are equal, what is the connection rule between them?

(The actual calculation is “switch” based, and will be explained in more detail in the implementation section later in this specification.)

1.2 Add each Chain Link to the collection, making sure each Chain Link is unique (i.e. a link is not added if it already exists in the collection)

2. Make all the possible chains of the above collection in the following way:

2.1 for each Chain Link with attribute “Begin”, search among those with attribute ‘Middle” or “End” for a Chain Link such that the current Links “Head” and the other Links “Tail” are “far ends” in the server layer trail. Put more simply, create the pieces of the trail that intersect with the BLSR ring. The building finishes when the link is connected with attribute “End”.

Note: a chain may have more then one Chain Link to continue it (for example in a split caused by “Protected” connection) so each time all available candidates are checked and, in case of two, the existing chain is duplicated and completed by using each of them separately. This part, because of its nature, is done recursively.

3. At this point there is a collection of all the possible chains from the original collection of Chain Links.

3.1 for each Chain, take the PortApsId of the “Head” TP of the first Chain Link.

3.2 allocate this number as a Squelch Aps Id in all the “Tail” TPs of all the rest of the Chain Links in the Chain.

Go Home!! (End of algorithm)

### EXAMPLE 1

For better understanding of the algorithm, a typical example of Match Node architecture will be described with reference to FIG. 19:

The numbers on the Nes are NE Id, but for simplicity are used as PortApsId (In reality, there is no relationship between the two)

The letters A, B and A′ relate to the tags in the co-related SNC.

In the description of stage 2, Chain Links are marked in the following syntax:

(NE id, Tail Tag, Head Tag)

For example (5,A,B) represents the Chain Link that goes from TP A to TP B in NE 5.

Stage 1:

The list of links to find are as follows:

| NE Id | Chain Links | Attribute |
|---|---|---|
| 1 | (1, A, B) | End |
| | (1, B, A) | Begin |
| 2 | (2, B, A) | End |
| | (2, A, B) | Begin |
| | (2, B, A′) | Middle |
| | (2, A′, B) | End (*) |
| 3 | (3, A, B) | Begin |
| | (3, B, A) | End |
| 5 | (5, A, B) | Middle |
| | (5, B, A) | Middle |
| 6 | (6, B, A) | End |
| | (6, A, B) | Begin |
| | (6, B, A′) | Middle |
| | (6, A′, B) | End (*) |
| 7 | (7, A, B) | Begin |
| | (7, B, A) | End |
| 9 | (9, A, B) | End |
| | (9, B, A) | Begin |

(*) Chain Link that represent protection leg into the main gets “End” attribute

Stage 2:

This is the list of all possible chains created:

1. (1,B,A) (2,B,A′) (5,B,A) (3,B,A)

2. (1,B,A) (2,B,A)

3. (3,A,B) (5,A,B) (2,A′,B)

4. (2,A,B) (1,A,B)

5. (9,B,A) (6,B,A′) (7,B,A)

6. (9,B,A) (6,B,A)

7. (7,A,B) (6,A′,B)

8. (6,A,B) (9,A,B)

Stage 3:

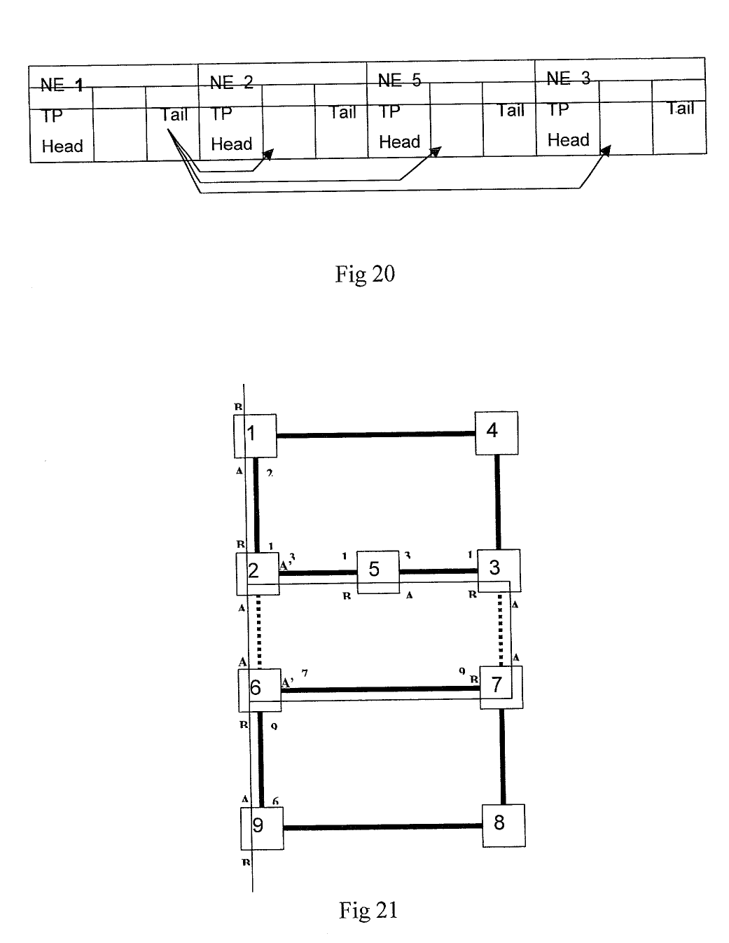

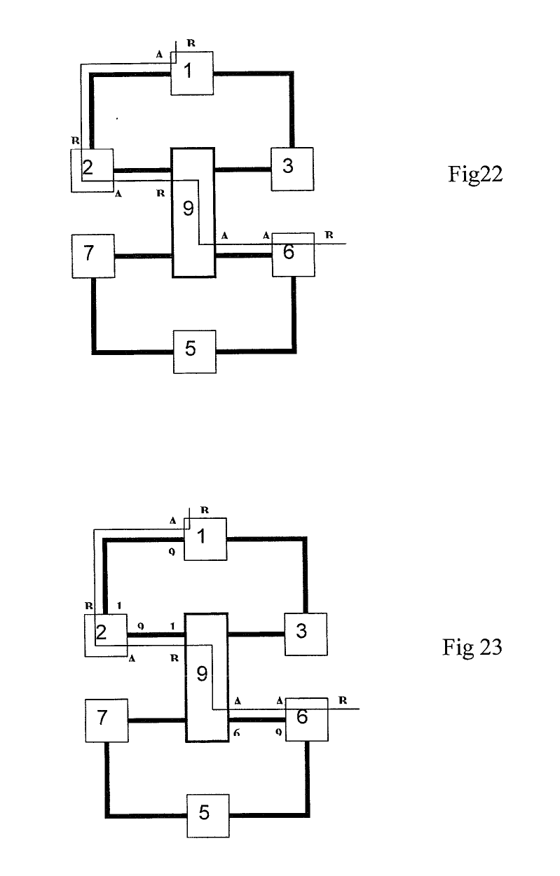

Stage 3 in chain No. 1 in the list above is illustrated in FIG. 20. The notation used in FIG. 20 is such that (*) indicates Squelch Id allocated when chain 4 is processed and (**) indicates Squelch Id allocated when chain 3 is processed.

Result: The result of this stage is indicated in FIG. 21.

### EXAMPLE 2 (Hub)

In this example NE 9 has the same PortApsId in all four TPs but in other cases it could have different allocation in every ring.

Stage 1:

The Chain Links collection is as represented in the following table:

| NE | Chain Links | Attribute |
|---|---|---|
| 1 | (1, B, A) | Begin |
| | (1, A, B) | End |
| 2 | (2, B, A) | Middle |
| | (2, A, B) | Middle |
| 9 | (9, B, A) | Begin & End |
| | (9, A, B) | Begin & End |
| 6 | (6, B, A) | Begin |
| | (6, A, B) | End |

Stage 2:

Collection of chains:

(1,B,A) (2,B,A) (9,B,A)

(9,A,B) (2,A,B) (1,A,B)

(6,B,A) (9,A,B)

(9,B,A) (6,A,B)

Links on the hub may take part in more then one Chain. For example, Link (9,A,B) takes part in Chains 2 and 3. Stage 3 is performed as in the first example. The results thus far are as represented in FIG. 23.

Implementation

The allocation algorithm is encapsulated in a class SquelchApsIdCalculator that supports the following public functions:

Parametric constructor the parameter is a pointer to a tmcCTrail object.

Notes:

The Database is assumed to be open and the SquelchIdCalculator holds no responsibility to close it. (i.e. No transaction handling)

AllocateSquelchId At this call the object will get into the Trail pointed by the pointer and put values for the SquelchApsId.

Main components of SquelchIdCalculator:

The SquelchIdCalculator consists of the following parts:

Pointer to tmcCTrail—This pointer will hold the DB source supplied by the user.

Aps TP List

Chain Link

Trail model—This is the collection (array) of all the Chains available from the Chain Links collection.

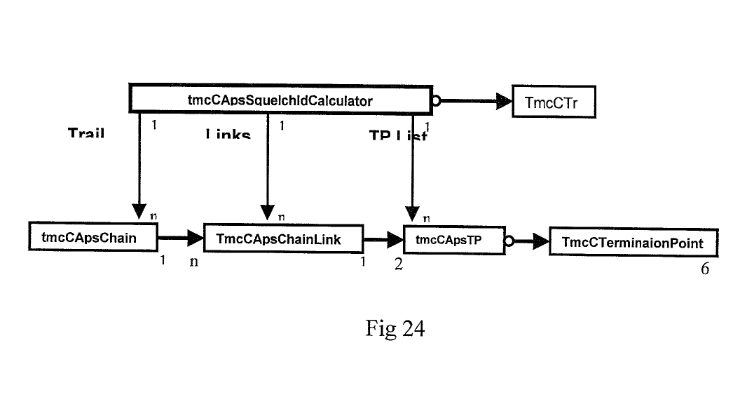

A block diagram of the allocation mechanism is illustrated in FIG. 24.

Structures description:

All classes described in this section are add classes that are defined for the purpose of the SquelchIdCalculator and meant to be used in the scope of this class only.

TmcCApsTP:

The Aps TP class stands for an endpoint in a Subnetwork connection.

Components:

class tmcCApsTP
{

public:

tmcCApsTP(tmcCTerminationPoint *pRealTP = NULL,

| tmcEApsTPSwitchMark eMyMark = tmcEApsTPSwitchMarkNONE, | |
|---|---|
| long | lMyPortApsId = ApsConstants::INVALID_PORT_APS_ID, |
| long | lMySquelchApsId = ApsConstants::INVALID_SQUELCH_APS_ID |

);

| //we use the default copy Ctor in the code of “tmcCApsSquelchIdCalculator::RegisterTP” | |
|---|---|
| //in a “new” statement | |
| ˜tmcCApsTP( ); | |
| RWBoolean operator= =(const tmcCApsTP &Ref) const; | |
| RWBoolean operator= =(const tmcCTerminationPoint *pRef) const; | |
| //Get function | |
| inline tmcCTerminationPoint | *GetMyRealTP( ) const |

{return m_pMyRealTP;}

| | |
|---|---|
| inline tmcEApsTPSwitchMark | GetMySwitchMark( ) const |

{return m_eMyMark;}

inline long GetMyPortApsId( ) const

{return m_lPortApsId;}

//Set function
inline void SetMyRealTP(tmcCTerminationPoint *pRealTP)

{m_pMyRealTP = pRealTP;}

inline void SetMySquelchId(int Model_SqId)

{m_lSquelchApsId = Model_SqId;}

// find the own PortApsId,set it and return its value
tmdCLogError SetApsId( );
tmdCLogError AllocateSquelchId(tmcCTrail *pTrail);
inline void SetPortApsAttrObj(tmcCaomTPAttribute *Ptr)

{m_pPortApsAttrObj = Ptr;}

inline void SetSquelchApsAttrObj(tmcCaomTPAttribute *Ptr)

{m_pSquelchApsAttrObj = Ptr;}

tmdCLogError GetMyFarEnd(tmcCTerminationPoint *&pFarEnd);

private:

| //private components// | |
|---|---|
| ////////////////////// | |
| tmcEApsTPSwitchMark | m_eMyMark; |

| | |
|---|---|
| long | m_lPortApsId; |
| long | m_lSquelchApsId; |

| tmcCTerminationPoint *m_pMyRealTP; | |
|---|---|
| tmcCaomTPAttribute *m_pPortApsAttrObj; | |
| tmcCaomTPAttribute *m_pSquelchApsAttrObj; | |
| //private methods // | |
| ///////////////////// | |
| tmcCApsTP &operator=(tmcCApsTP &source) ;//assignment operator in private not applicable | |
| tmcCApsTP(tmcCApsTP &Ref); | // copy Ctor in private not applicable |

};//tmcCApsTP

Switch Mark—i.e. A,B,A′, or B′

Port APS ID—An integer with default invalid value of (−1) or the value retrieved from the DB immediately after the object's creation

Squelch APS ID—An integer with default invalid value of (−1) or the value calculated when the Trail Model is made (see section 3.1.3)

Pointer to Real TP—pointer to class tmcCTerminationPoint which is the real TP in the DB which this ApsTP represents

The Port supports the “==” operator which relay on the “==” operator of the tmcCTerminationPoint class pointed by the Real TP pointers.

Aps Chain Link

An Aps Chain Link is an ordered pair of Aps TP and is the basic brick of the model construction.

class tmcCApsChainLink
{

public:

tmcCApsChainLink(tmcCApsTP *pTail=NULL,

tmcCApsTP *pHead=NULL);

inline tmcCApsTP *GetTail( ) const

{return m_pTailTP;}

inline tmcCApsTP *GetHead( ) const

{return m_pHeadTP;}

tmdCLogError SetAttribute( );
inline const ChainLinkAttrib &Attribute( ) const
{return m_MyAttribute;}
RWBoolean operator=(const tmcCApsChainLink &Ref) const;

private:

| tmcCApsChainLink &operator= =(tmcCApsChainLink &Ref); //assignement poerator in private | |
|---|---|
| //Private members // | |
| //////////////////// | |
| tmcCApsTP *m_pHeadTP; | |
| tmcCApsTP *m_pTailTP; | |
| ChainLinkAttrib | m_MyAttribute;//see attribut defined in apshcomondef.hxx |
| //Private functions // | |
| ////////////////////// | |

tmdCLogError MyStatusInTheRing(tmcEApsChainLinkInRing &StatusInRing);
tmcEApsChainLinkConfig MyConfig( );
tmdCLogError AreTPsInTheSameRing(RWBoolean &answer);

};//tmcCApsChainLink

Components:

Two pointers to Aps TP one labelled “Head” and one “Tail”

Links attribute—This attribute relates to the optional location of the Link object within a Chain (see below). The options are “Begin”, “End” or “Middle”. A Link may have in some cases both “Begin” and “End” attributes. The Attribute(s) is calculated due to the properties of the Aps TPs that constitute the Chain Link.

The Chain Link supports the “==” operator. This operator relay on the operator “==” of Aps TP. The Chain Link operator compares the Aps TP of two Chain Links.

Aps Chain

An Aps Chain is a vector (i.e. Ordered group) of Chain Links, starting with a “Begin” attributed Link and ending with an “End” attributed link, where all the rest are “Middle” labelled.

This class actually wraps the array, mainly to prevent the user of the class from using the insert option over the array.

class tmcCApsChain
{

public:

inline int Length( ) const

{return m_vTheCahin.length( );}

inline void AddChainLinkToChain(tmcCApsChainLink
*pChainLink)

{m_vTheCahin.append(pChainLink);}

inline tmcCApsChainLink *Last( ) const

{return m_vTheCahin.last( );}

inline tmcCApsChainLink *operator[](int index) const

{return m_vTheCahin[index];}

private:

RWTPtrOrderedVector<tmcCApsChainLink> m_vTheCahin;

};//tmcCApsChain

Trail Model

Trail Model is a group of all the Aps Chains that can be created from the Chain Links in the link list due to the connectivity between TPs held by the ApsTP objects.

typedef RWTPtrOrderedVector<class tmcCApsChain>tmcCApsTrailModel;

Flow of the “tmcCApsSquelchIdCalculator” main functions:

1. Make Trail Model

The actual implementation of the Algorithm is issued in the way the model is built.

1.1. Make Aps TP & Chain Link Lists

0. Get all SNC from the Real Trail

1. For every SNC

For every TP in the SNC:

Does the TP have a “Squelch APS Id” attribute?

NO—Do nothing.

YES

1.1 Create Aps TP object of self and register* it to Aps TP List

1.2 Create Aps TP of neighbour and register* it to Aps TP List

1.3 Create Chain Link of self and Neighbour and register* it to Chain Link List.

1.4 Call this Link to define its attribute.

1.5 Repeat 1.3 and 1.4 with the “head” and “tail” TPs the other way around. (*)The term “register” means Compare the new item with those already existing in the list. If there is an equal item in the list, link to the existing and delete the new. Otherwise, add new item to the list.

1.2.Create Trail Model:

1.2.1.Create all possible chains:

This is a recursive function. Stage 1 is a simple “for” statement in the function “CreateAllPossibleChains( )”. Parts 1.1-1.4.2 are wrapped in the recursive function “RecursiveChainBuild(tmcCApsChain &Chain)”

For every Chain Link in the Chain Link List that owns a “Begin” attribute (The recursive part)

1.1 Take the “Head TP” of the last Chain Link in the Chain and find the Real TP it owns.

1.2 Using the “Get far end” service of “tmcCTerminationPoint” locate the TP of the next Chain Link's Tail.

1.3 Compare the new TP with the “Tail” TP of ALL the Chain Links in the list that have attribute “Middle” or “End” (there might be more then one)

1.3.1 When found, match Chain Link, Duplicate the Chain build so far and append the new Chain Link to the new copy of the Chain.

1.3.2 If the new Chain Link owns “End” attribute, add the new copy to the “Chain List” (recursive end condition)

1.3.3 Else, repeat 1.1-1.4 with the new copy (recursive call)

1.4 delete the original chain.

Notes:

The recursive implementation is chosen because the number of continuing chains in stage 1.3 is not known in advance, and the nature of the problem is like searching in an unknown tree.

In the process chains are created and deleted frequently. These are arrays of pointers and therefore those operations are not expensive in performance.

Calculate Squelch ID on Model

This routine is called after the Trail Model established. This function implies in a simple way the last section of the algorithm.

For ( I =0 ; I <TrailModel.size ; ++I)
{

The Id = TrailModel[ I ] -> At[0] -> Head TP . Get My Port APS Id
For (J = 1 ; J< TrailModel[ I ] ->Size ; ++J)
{

TrailModel[ I ] -> At[J] -> Tail Port . Set Squelch Id ( The Id)

}// For

}//For

Allocate Squelch ID

This routine is called when the Trail Model exists and the Squelch Ids are already allocated in the model.

It minds that every ApsTP in the TP List has a valid Squelch Id allocated. All that is left to do is to go over the TP List and for each Aps TP to allocate the valid ID into the real TP pointed by it.

Destruction

The destruction is in the following order:

1. free all ports from the list

2. free all links from the list

3. free all chains from the Trail Model

Flow of the “tmcCApsChainLink” main functions:

Set Attribute:

Chain Link has an attribute “Begin”, “End” or “Middle” according to two elements:

1. The status in the ring: being a unidirectional item the Chain Link can “enter ring”, “exit from ring”, “in the middle” or “go from ring to ring”

2. The configuration of the Chain Link within the SNC. For example, a link in which its tail is “A prime” and its head is “B” will always get the attribute “End” because such Chain Link is the joining of a protection leg into the main leg of the trail.

The function is first call “MyStatusInTheRing( )” to calculate the 1^{st} condition mentioned above. It then enters a double “switch” (i.e. nested switch) statement over the two condition to determine the attribute.

“My Status In The Ring”

This function is simply to go with an “if-else” statement over a few possible options:

If “Tail” TP has no Port Aps Id and “head” does, then the Chain Link “Enter Ring” status.

If it is the other way around, it is of course, “Exit Ring”

If both TPs have valid Ids but different, it means that the Chain Link goes from one ring to another within a Hub NE.

If both TPs have the same (valid) value, “AreTPsInTheSameRing( )” is called (see description below) to evaluate whether the ports are of the same ring or not.

There is also special treatment with special case of SNC of type “unprotected” with only one TP but this is of little interest to the system.

Are TPs In The Same Ring?

In case the two TPs have the same PortApsId it may be the normal NE in the middle of a ring or it might be the case of hub configuration where the ports have the same ID in both rings.

When an NE is set in hub configuration, each pair of aggregates share separate CTP groups that define them as belonging to the same ring. Groups of this kind are marked with special fixed TPAM attributes and the value of this TPAM marks the group. In this function this value from the “head Tp” and the “tail Tp” is searched for. If both values are equal then the two TPs are of the same hub-group and therefore of the same ring.

In the case where the configuration is not a hub configuration, the search ends with empty strings which is a valid result. In other words, if the search for both TPs comes back with (“”) it implies a normal NE and the ports are of the same ring.

Error handling:

As soon as this feature is implemented, all trails should be provisioned with the support of APS ID (if applicable). Failure in the calculation of APS IDs is enough reason not to submit the applied trail. In the light of those guiding lines the approach in error handling is success only. In other words, every unsuccessful stage in the flow of the calculation will cause a complete failure.

All non-void functions in the feature use “tmdCLogError” as their return class where the return codes are simply “OK” or “Not OK”. This error handling concept enables the comfortable code style of the negative approach instead of using the “if/else” nesting approach.

### EXAMPLES

“negative approach”:
TmdCLogError Function (....)
{

tmdCLogError RV;
RV = StageOne(....)
If(RV.Code != OK)
{

return RV;

}
//stage 2 is executed in the same scope of stage 1.
.......
return RV;

}
“if/else nesting approach”
TmdCLogError Function (....)
{

tmdCLogError RV;
RV = StageOne(....)
If(RV.Code == OK)
{

//stage 2 is nested in the “if” statement
.......

}
else
{

//error handling

}

}

The advantage of the negative approach becomes apparent as soon as a function with three or four stages is considered.

SUMMARY

It can thus be appreciated that the invention provides a unique solution to the provision and allocation of squelch IDs to network elements of a communication system or network.

What we claim is:

1. A method of allocating squelch identifiers in a communication network incorporating BLSR protection, the network comprising a plurality of interconnected network elements, the method comprising:
Determining chain links between network elements;
Setting attributes (begin, middle, end) corresponding to the chain links;
Building chains by joining chain links together;
Matching pairs of chains connecting network elements at the ends of chains; and
Allocating squelch identifiers to those network elements interconnected by matching pairs of chains.

2. A method as claimed in claim 1, wherein the step of building chains comprises joining chain links having matching termination points.

3. A method as claimed in claim 1, wherein the step of matching pairs of chains comprises searching for chains interconnecting the same two network elements but pointing in opposite directions.

4. A method as claimed in claim 1, wherein each chain link consists of a network element termination point at each end and an intermediate sub-network connection.

5. A BLSR-protected communication network provided with squelch identifiers by the method claimed in claim 1.

6. A communication signal transmitted over a BLSR-protected communication network as claimed in claim 5.

7. A carrier for an algorithm adapted to perform the squelch identifier allocation method as claimed in claim 1.
